(19) United States
(12) Patent Application Publication
(10) Pub. No.: US 2008/0181388 A1
(43) Pub. Date: Jul. 31, 2008

(54) Telephone exchange system and service providing method for use in the system

(75) Inventor: Hideaki Nakai, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/902,860

(22) Filed: Sep. 26, 2007

(30) Foreign Application Priority Data
Sep. 28, 2006 (JP) 2006-265844

(51) Int. Cl. H04M 7/00

(52) U.S. Cl. 379/229

(57) ABSTRACT

According to one embodiment, a telephone exchange system includes a telephone exchange apparatus which accommodates a plurality of telephone terminals and is configured to connect a public network, a server apparatus which is connected to the telephone exchange apparatus and provides a service to execute at least a part of functions regarding exchange processing of the telephone exchange apparatus to telephone terminals on the public network, and a connector which conference-connects among a first telephone terminal to be an outgoing call origin, a second telephone terminal to be an incoming call destination and the server apparatus, when an incoming call arrives at the telephone exchange apparatus and it is determined that an incoming call destination is any one of the telephone terminals on the public network.

### CROSS-REFERENCE TO RELATED APPLICATIONS

This application is based upon and claims the benefit of priority from Japanese Patent Application No. 2006-265844, filed Sep. 28, 2006, the entire contents of which are incorporated herein by reference.

### BACKGROUND

1. Field

One embodiment of the present invention relates to a telephone exchange system includes a telephone exchange apparatus, and a media control server which is connected to the telephone exchange apparatus and provides a service to execute at least a part of functions of the telephone exchange apparatus to telephone terminals on a public network, and a service providing method for use in the telephone exchange system.

2. Description of the Related Art

In recent years, a communication system for proving a variety of services regarding a voice communication by using the media control server. A system of this kind connects the media control server to the telephone exchange apparatus, performs basic processing, regarding exchange connections of inter-line switching, etc., inside the telephone exchange apparatus, and executes additional and applied processing regarding the exchange connections of the relevant telephone exchange apparatus.

In the exchange system given above, when it is desired to use an additional service executed by the media control server, a caller of a telephone terminal accommodated in the telephone exchange apparatus transmits a service number consisting of a dual tone multi frequency (DTMF) signal by means of a dial operation, the media control server detects the DTMF signal then the exchange system enables executing a service corresponding to the service number. Such a service is considered to be that records a voice sent from an outgoing destination in incoming a call, notifies the recorded voice to a user, and reads an e-mail.

Conventionally, a method for mapping DTMF signals input from a cellular phone on a public network onto one piece of bit string together with an image signal, etc., detecting the DTMF signal from a voice signal obtained by separating it through a gateway, then, allowing a desired service to be used by means of the cellular phone has been proposed (e.g., Jpn. Pat. Appln. KOKAI Publication 2005-33664.)

By the way, in the aforementioned system, a system, such that also allows the cellular phone on the public network to utilize, for example, extension services for transference, park holding, “Return Call”, etc., which have been implemented by a stand-alone telephone exchange apparatus to be used, has been desired strongly. However, these extension services are in their examination stages, and they are not attained yet as it now stands.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred schematic configuration view depicting a telephone exchange system regarding the first embodiment of the invention;

FIG. 2 is a preferred block diagram depicting a functional configuration of a main apparatus and a media control server depicted in FIG. 1;

FIG. 3 is a preferred sequence view depicting transfer operations from a communication between a public network and an extension to another extension regarding the first embodiment of the invention;

FIG. 4 is a preferred sequence view depicting park holding operations as the second embodiment of the invention; and

FIG. 5 is a preferred sequence view depicting “Return Call” operations as the third embodiment of the invention.

### DETAILED DESCRIPTION

Various embodiments according to the invention will be described hereinafter with reference to the accompanying drawings, In general, according to one embodiment of the invention, a telephone exchange system, comprising: a telephone exchange apparatus which accommodates a plurality of telephone terminals and is configured to connect a public network; a server apparatus which is connected to the telephone exchange apparatus and provides a service to execute at least a part of functions regarding exchange processing of the telephone exchange apparatus to telephone terminals on the public network; and a connector which conference-connects among a first telephone terminal to be an outgoing call origin, a second telephone terminal to be an incoming call destination and the server apparatus, when an incoming call arrives at the telephone exchange apparatus and it is determined that an incoming call destination is any one of the telephone terminals on the public network.

### First Embodiment

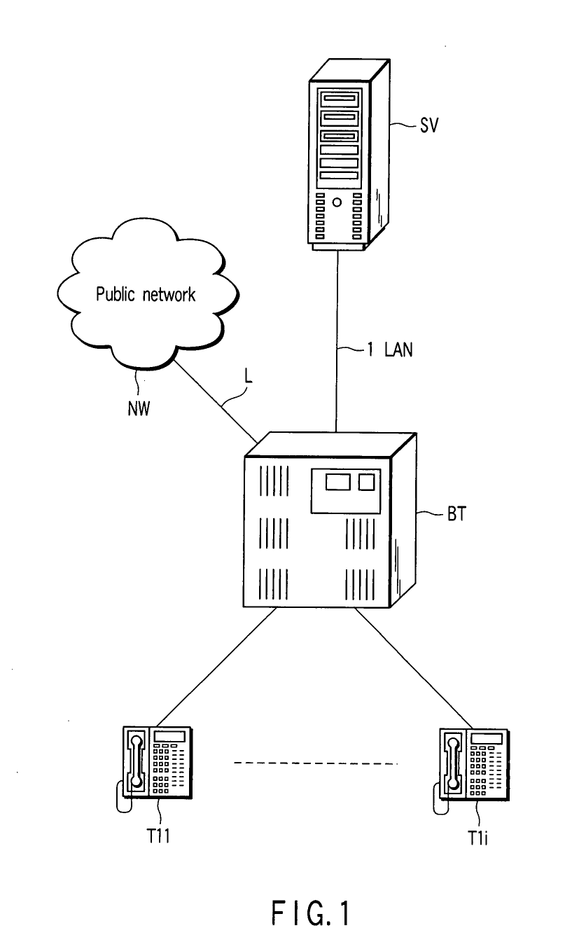

FIG. 1 is a schematic configuration illustrating a telephone exchange system regarding the first embodiment of the invention. As illustrated in FIG. 1, the exchange system includes a main apparatus BT and a media control server SV, and connects between the main apparatus BT and the server SV through a local area network (LAN) 1.

The main apparatus BT accommodates key telephone sets T11-T1i via extension lines. The main apparatus BT is connected to a public network NW via a trunk line L. The main apparatus BT executes exchange processing inter-key telephone sets T11-T1i, or among the key telephone sets T11-T1i and the public network NW.

The server SV comprises a CPU, a hard disk drive, etc., and conducts a part of functions of the main apparatus BT such as processing of a voice mail.

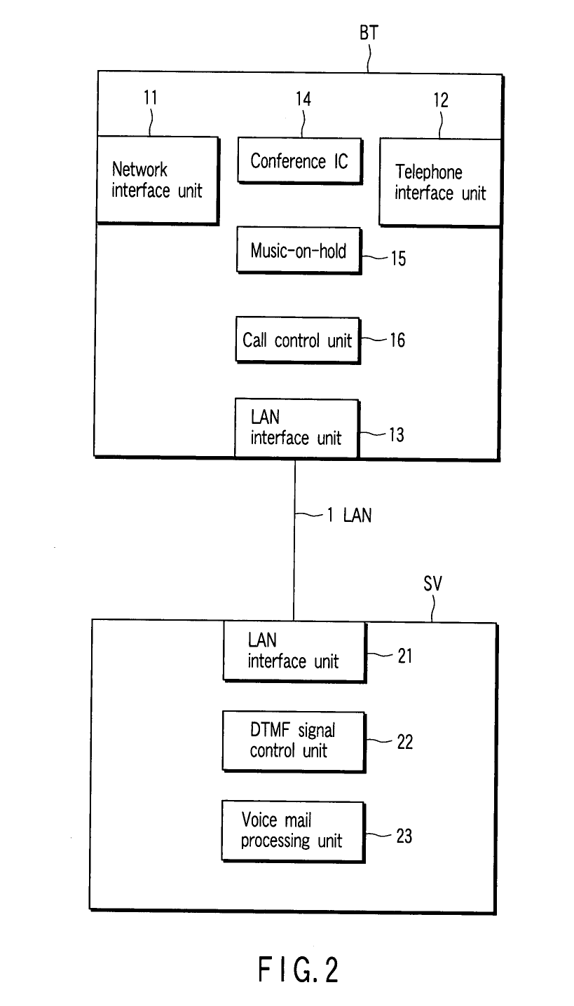

FIG. 2 is a functional block diagram illustrating each concrete configuration of the main apparatus BT and the server SV.

The main apparatus BT includes a network interface unit 11, a telephone interface unit 12, a LAN interface unit 13, a conference IC 14, a holding tone source (hereinafter referred to as music-on-hold (MOH)) 15, and a call control unit 16.

The network interface unit 11 is connected to the public network NW and conducts establishment processing of a call etc. to and from the public network NW.

The telephone set interface unit 12 accommodates a plurality of key telephone sets T11-T1i. The interface unit 12 performs outgoing/incoming call processing, transfer processing of digital signal, etc., for the key telephone sets T11-T1i.

The LAN interface unit 13 conducts interface processing to and from the LAN 1.

A conference IC 14 makes a three-party conference connection under the control by the call control unit 16. The MOH 15 generates a holding tone under the control by the call control unit 16.

The call control unit 16 has an incoming call response control function using the server SV in addition to a normal control function such as transmission processing accompanied by call requests from each key telephone set T11-T1i, and normal incoming call processing and outside line call transmission processing accompanied by outside line incoming call from the public network NW, and transfer processing among key telephone sets T11-T1i. When the key telephone set T11 of an incoming call destination does not answer for an incoming call, the incoming call response control function makes a call for the incoming call to the server SV to connect between the server SV and an outgoing call origin, thereby, it controls so as to transmit a prescribed announce message to the outgoing call origin.

When determining that the incoming call destination is a terminal on the public network NW at an arrival of the incoming call, the call control unit 16 controls the IC 14 to make a conference connection among the key telephone set T11 of the outgoing call origin, the server SV and the incoming call destination.

The server SV includes a LAN interface unit 21, a DTMF signal control unit 22, and a voice mail processing unit 23.

The signal control unit 22 carries out transfer control, park holding control, “Return Call” control, etc., based on a DTMF signal transmitted from the main apparatus BT.

The mail processing unit 23 has mail boxes corresponding to the key telephone sets T11-T1i, and the terminals on the public network NW, respectively, and accumulates voice messages from callers in arbitrary mail boxes.

Next, operations of the exchange system configured as mentioned above will be described.

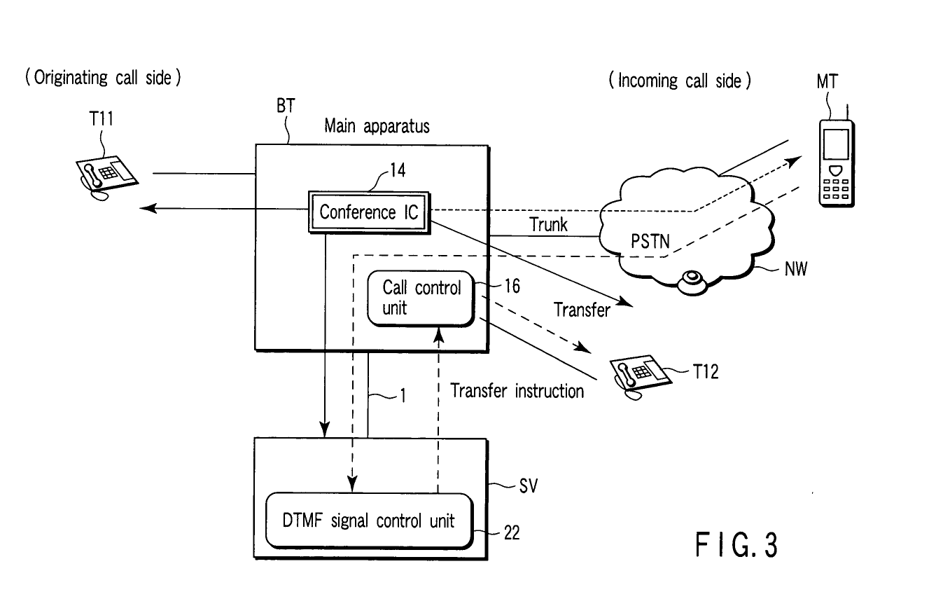

FIG. 3 is a sequence view showing transfer operations from the communication between the public network and the extension to another extension.

It is presumed that, at first, the key telephone set T11 accommodated in the main apparatus BT performs an outgoing call operation toward the public network NW for a cellular telephone set MT. The main apparatus BT then grasps the public network NW to call the telephone set MT in accordance with a result of an inquiry concerning an actual incoming call destination to the server SV by using a destination dial number as a key, and establishes a communication link between the key telephone set T11 and the telephone set MT in accordance with the response from the telephone set MT. At this moment, the exchange system does not release the connection with the server SV, and configures a three-party conference through the conference IC 14 internally.

In a state in which a speech is made between the key telephone set T11 and the cellular telephone set MT, it is supposed that the user of the telephone set MT performs an operation to require transfer of the speech from the telephone set MT to another key telephone set T12. Then, a DTMF signal, specifying a preset transfer special number and a transfer destination extension number, is transmitted from the telephone set MT to the main apparatus BT.

When the signal control unit 22 mounted on the server SV detects the DTMF signal, the exchange system presumes the DTMF signal as the transfer special number through special number analysis processing of the signal control unit 22, and transmits a transfer instruction message with the transfer destination extension number added thereto to the call control unit 16 mounted on the main apparatus BT.

When receiving the instruction message from the server SV, the call control unit 16 determines a free/busy state of the key telephone set T12 corresponding to a transfer destination extension number added to the message, and if it determines that an incoming call can be terminated, it transmits an incoming call signal to the key telephone set T12 and a disconnection signal to the trunk line, respectively, and disconnects a communication link to and from the telephone set MT.

When the key telephone set T12 responds to an incoming call, the main apparatus BT releases the connection with the server SV.

Thus, the communication destination of the key telephone set T11 is switched from the cellular telephone set MT to the key telephone set T12, after this, it allows the user of the telephone set T11 to perform an interactive speech to and from the user of the key telephone set T12 in succession.

As given above, in the first embodiment, when the incoming call arrives at the cellular telephone set MT on the public network NW, the main apparatus BT automatically calls the server SV to make a conference connection among the key telephone set T11 to be the outgoing call origin once, the cellular telephone set MT to be the incoming call destination, and the server SV. In such a state of the conference connection, the system, for example, allows a speech in succession by switching the communication partner of the key telephone set T11 from the cellular telephone set MT to the key telephone set T12 in response to the request from the user of the telephone set MT being in speech. In other words, the system enables to provide an equivalent function, even via the public network NW, to the transfer function which has been provided from the conventional telephone exchange system by controlling the DTMF signal which has been transmitted from the cellular telephone set MT to the server SV.

Accordingly, even the cellular telephone set MT may transfer a communication as an extension service without having to conduct a special operation, thereby the convenience of the user of the cellular telephone set MT is extremely improved.

### Second Embodiment

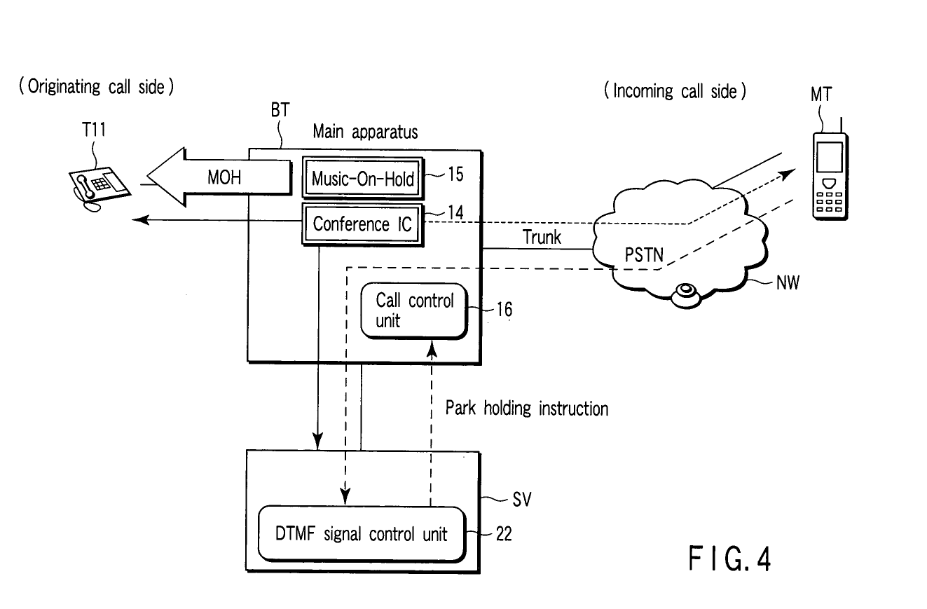

FIG. 4 is a sequence view showing park holding operations as the second embodiment of the invention. In FIG. 4, the same components as those of the FIG. 3 are designated by the identical symbols and the detail description thereof will be omitted.

It is presumed that, at first, the key telephone set T11 accommodated in the main apparatus BT performs a transmitting operation toward the public network NW for the cellular telephone set MT. The main apparatus BT then grasps the public network NW to call the cellular telephone set MT in accordance with a result of an inquiry of an actual incoming call destination depending on the call destination dial number as a key to the media control server SV, and establishes a communication link between the key telephone set T11 and the telephone set MT in response to the answer from the telephone set MT. At this moment, the exchange system does not release the connection with the server SV to internally configure a three-party conference via the conference IC 14.

In a state in which a speech is made between the key telephone set T11 and the telephone MT, it is supposed that a user conducts an operation to require park holding by means of the telephone set MT. The telephone set MT then sends a DTMF signal specifying a preset park holding special number and an orbit number to the main apparatus BT.

When detecting the DTMF signal, the DTMF signal control unit 22 mounted on the server SV assumes that the DTMF signal is the park holding special number by means of special number analysis processing of the control unit 22, and transmits a park holding instruction message with the orbit number added thereto to the call control unit 16 mounted on the main apparatus BT.

When receiving the instruction message from the server SV, the call control unit 16 connects a voice path for the key telephone set T11 now in speech to and from the telephone set MT to the MOH 15 to bring itself into a park holding state, then, allows responses from other terminals. The cellular telephone set MT shifts itself to a two-party speech state to and from the server SV.

The telephone set MT may return to the speech with the key telephone set T11 by further sending the park holding response special number through the DTMF signal while maintaining the two-party speech state to and from the server SV, and also may release the connection with the server by means of a speech terminating operation.

As mentioned above, in the second embodiment, the telephone exchange system may provide a function equivalent to the park holding function provided from the conventional telephone exchange system even via the public network NW by controlling the DTMF signal transmitted from the telephone set MT to the server SV.

### Third Embodiment

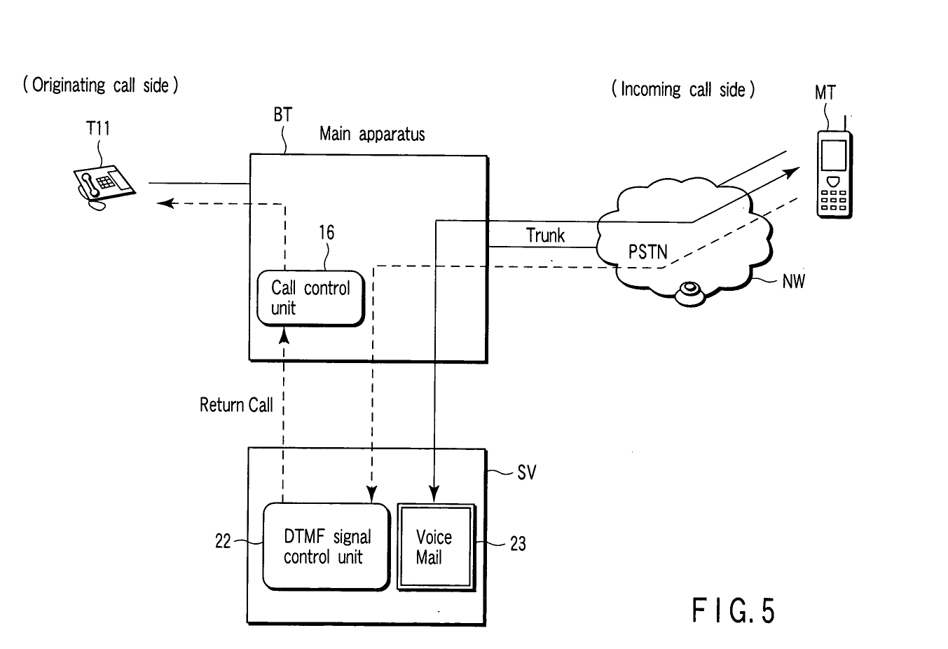

FIG. 5 is a sequence view illustrating “Return Call” operations as the third embodiment of the invention. In FIG. 5, the same constituent elements as those of FIG. 3 are designated by the identical symbols and detailed description thereof is eliminated.

It is assumes that, at first, the key telephone set T11 accommodated in the main apparatus BT carries out a transmitting operation toward the main apparatus BT for the cellular telephone set MT. Then, inquiring an actual incoming call destination to the server SV by using a call destination dial number as a key produces a result in which the main apparatus BT grasps the public network NW to call the telephone set MT.

In contrast, in the case that the telephone set MT does not make any answer after the elapse of a fixed time period, the key telephone set T11 re-connects itself to the server SV, and records a message in a mail box preset to the telephone set MT to terminate the communication.

When the telephone set MT makes a call to the server SV connected to the main apparatus BT via the LAN 1 from the telephone set MT via the public network NW, the telephone set MT becomes a two-party speech state between the telephone set MT and the voice mail processing unit 13 mounted on the server SV, the key telephone set T11 listens the message recorded in the mail box set to the telephone set MT.

In this state, it is presumed that the user of the telephone set MT conducts an operation to require a “Return Call” to the key telephone set T11 during listening of a message recorded in the mail box of the processing unit 23. Then, a DTMF signal specifying a preset “Return Call” is sent to the main apparatus BT from the telephone set MT.

When the DTMF signal control unit 22 mounted on the server SV detects the DTMF signal, the DTMF signal control unit 22 assumes that the DTMF signal is the “Return Call” special number through the special number analysis processing of the signal control unit 22, and transmits a “Return Call” instruction message with the “Return Call destination telephone number added thereto to the call control unit 16 mounted on the main apparatus BT.

When the call control unit 16 receives the “Return Call” instruction message from the server SV, the control unit 16 sends an incoming call signal to the key telephone set T11 corresponding to the “Return Call” destination telephone number added to the message, and sifts to the two-party speech state between the cellular telephone set MT and the key telephone set T11 that is a message transmitting source.

When detecting the speech termination of the key telephone set T11, the server SV returns the exchange system to the two-party speech state between the cellular telephone set MT and the mail processing unit 23 to start reproduce the following message.

As mentioned above, in the third embodiment, controlling the DTMF signal sent from the telephone set MT to the server SV enables providing a function equivalent to the “Return Call” function provided from the conventional telephone exchange system even via the public network NW, and makes it possible to access a transmitting source of the message recorded to be addressed oneself from the outside of the company.

### Other Embodiment

The present invention is not limited to each foregoing embodiment. For example, in each embodiment, while the example has been described by taking the example of the case in which a variety of types of control regarding the extension service, such as communication transfer control, park holding control, and “Return Call” control in response to the request operation from the cellular telephone set, a variety of types of control regarding the extension service may be carried out in response to, for example, a request operation from a fixed telephone set on the public network.

Having described an example in which the transmitting source is the key telephone set to be accommodated in the main apparatus, it is believed obvious that the transmitting source may be a standard telephone set and a cellular telephone set on the public network.

Other than this, a configuration of a telephone system, a functional configuration of a main apparatus, a type of a server apparatus such as a media control server, each procedure and its content, etc., of communication transfer control, park holding control, “Return Call” control may be embodied in various forms without departing from the spirit or scope of the general inventive concept thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange system, comprising:
a telephone exchange apparatus which accommodates a plurality of telephone terminals and is configured to connect a public network;
a server apparatus which is connected to the telephone exchange apparatus and provides a service to execute at least a part of functions regarding exchange processing of the telephone exchange apparatus to telephone terminals on the public network; and
a connector which conference-connects among a first telephone terminal to be an outgoing call origin, a second telephone terminal to be an incoming call destination and the server apparatus, when an incoming call arrives at the telephone exchange apparatus and it is determined that an incoming call destination is any one of the telephone terminals on the public network.

2. The telephone exchange system according to claim 1, further comprising:
a service execution unit which transmits a dual tone multi frequency signal specifying information to start the service from the telephone exchange apparatus to the server apparatus, and executes the service based on information specified by the dual tone multi frequency signal received by the server apparatus, when user of the second telephone terminal operates to start the service.

3. The telephone exchange system according to claim 2, wherein the service execution unit transmits a dual tone multi frequency signal indicating a transfer special number from the telephone exchange apparatus to the server apparatus, and switches a communication destination of the first telephone terminal to a third telephone terminal based on the dual tone multi frequency signal received by the server apparatus, when user of the second telephone terminal performs a transfer operation to the third telephone terminal.

4. The telephone exchange system according to claim 2, wherein the service execution unit transmits a dual tone multi frequency signal indicating a park holding special number from the telephone exchange apparatus to the server apparatus, and executes park holding to the second telephone terminal based on the dual tone multi frequency signal received by the server apparatus, when user of the second telephone terminal performs a park holding operation to temporarily hold a communication with the first telephone terminal.

5. The telephone exchange system according to claim 2, wherein the service execution unit transmits a dual tone multi frequency signal indicating a callback call special number from the telephone exchange apparatus to the server apparatus, when user of the second telephone terminal performs a callback call operation to the first telephone terminal, and connects the first telephone terminal and the second telephone terminal with each other by calling the first telephone terminal, when it is determined that the first telephone terminal is possible to be called based on the dual tone multi frequency signal received by the server apparatus.

6. The telephone exchange system according to claim 1, wherein the second telephone terminal is a cellular telephone set.

7. A service providing method for use in a telephone exchange system which comprises a telephone exchange apparatus which accommodates a plurality of telephone terminals and is configured to connect a public network; and a server apparatus which is connected to the telephone exchange apparatus and provides a service to execute at least a part of functions regarding exchange processing of the telephone exchange apparatus to telephone terminals on the public network, comprising:
conference-connecting a first telephone apparatus to be an outgoing call origin and a second telephone terminal to be an incoming call destination, when an incoming call arrives at the telephone exchange apparatus and it is determined that the incoming call destination is a telephone terminal on the public network;
transmitting a dual tone multi frequency signal specifying information to start a service from the telephone exchange apparatus to the server apparatus, when user of the second telephone terminal operates to start the service; and
executing the service based on a content of information to be specified by the dual tone multi frequency signal received by the server apparatus.
